(19) United States
(12) Patent Application Publication
(10) Pub. No.: US 2014/0360600 A1
(43) Pub. Date: Dec. 11, 2014

(54) OPTIMIZED MULTI-FUNCTIONAL FLOW CONTROL DEVICE

(71) Applicant: Advanced Technical Solutions Gmbh, Berlin (DE)

(72) Inventor: AHMED MOHAMED MOHAMED OMER, DOHA (QA)

(73) Assignee: Advanced Technical Solutions Gmbh, Berlin (DE)

(21) Appl. No.: 14/292,865

(22) Filed: May 31, 2014

Related U.S. Application Data
(60) Provisional application No. 61/830,069, filed on Jun. 1, 2013.

(51) Int. Cl. F16K 11/085; F16K 5/04

(52) U.S. Cl. CPC F16K 11/0856; F16K 5/0407
USPC 137/549; 137/625.22

(57) ABSTRACT

A multi-functional flow control device optimized for maintaining a substantially specific flow rate of fluid with the requirements to properly connect, commission, set-to-work, maintain, repair, and/or replace hydronic apparatus and equipment. The device includes two valve housings hydraulically communicating with each other, one is fixed to the supply line and the other is connected to the return line connection point of the hydronic apparatus. Each of the two valve housings have a primary inlet port and a primary outlet port, a secondary inlet port and a secondary outlet port, multiple cylinders with strategically positioned peripheral openings in the form of perforations. A first valve housing includes a first hollow cylinder, a mesh strainer, a drain valve, a cover plate, a handle and stem mechanism with a stem dial. A second valve housing includes a second hollow cylinder, a nested cylinder, a venturi tube, a cover plate and a motor.

### CROSS REFERENCE TO RELATED APPLICATIONS

This application claims the benefit of U.S. Provisional Patent Application No. 61/830,069, filed Jun. 1, 2013, entitled “OPTIMIZED MULTI-FUNCTIONAL FLOW CONTROL DEVICE.”

### FIELD OF THE INVENTION

The present invention deals generally with flow control devices and more particularly with improvements in multi-functional flow control device optimized for maintaining a substantially specific flow rate of fluid in hydronic systems.

### BACKGROUND OF THE INVENTION

Hydronic systems include fluid (e.g., water) based apparatus like boilers, air handling units, cooling chillers, Fan coil units, chilled water pumps, circulating pumps, heating water pumps, cooling towers and other apparatus. In order to connect, operate, maintain and control a specific flow rate of fluid into these hydronic systems, a set of valves and accessories are used in applications for homes, commercial spaces, or any building and/or construction facility.

However, due to the application of bulk size of valves used in domestic and industrial applications, there is considerable consumption of space and thereby increasing installation costs. Further, to maintain the required flow rate of water using huge valves and sophisticated controls during the pressure variation may be costly, requires considerable space and installation time.

Over the past decades, in conventional systems, it is a normal practice to have the following requirements for the hook-up of hydronic systems 30 of each of the units mentioned as shown in the prior art figure.
1. Shut-off valves 10a and 10b, one at the inlet and the other one at the outlet of hydronic system 30 to isolate it from the entire hydronic circuit during maintenance and/or replacement.
2. Water strainer 12 to prevent any solid particulate beyond a certain size from entering into the hydronic system 30 to avoid any possible damage or clogging of this relatively precious apparatus.
3. Water Drain Valve 14 to de-pressurize and drain the hydronic system 30 during maintenance
4. Water regulating valve 16 to adjust the required flow rate of water being introduced into the hydronic system 30 to avoid overflow and in turn avoid underflow in another unit connected to the same hydronic system 30.
5. Water measuring device 18 to measure the flow rate of water entering into the hydronic system 30. The water measuring device 18 can be a separate device or can be included along with the water regulating valve 16.
6. Automatic Control Valve 20 to automatically control the flow rate of water based on a pre-defined signal like temperature or pressure or any other signal where a control action is required to match a pre-defined set-point.
7. In addition to the above, some accessories and instrumentation provisions are required like connecting unions and flanges, water outlet for pressure gauges 22a and 22b, wells for thermometers 24a and 24b and others.
8. By-pass line 26 between supply and return line complete with shut-off valve is normally required to do circuit pipe cleaning and flushing process without affecting the hydronic system 30.
9. The whole assembly is utilized in many applications, especially in cooling that requires thermal insulation, to minimize heat losses and to avoid condensation in case of cooling.

The following graph illustrates a possible example of how this water hook-up system can look like.

It is clear that this system require huge space, labor works, and long time for installation, commissioning, testing and set to work. Further, it requires a lot of on-site installation works since practically there is no one single product that can provide all of these required functions together. Also, concatenating all the individual set of valves and accessories is cumbersome and arrangement of all the internal components to do multi-functional operations has been a challenge.

Further, there is a need to have an easy-to-handle, multi-functional flow control valve which is designed to perform all the required operations as mentioned earlier. The multi-functional flow control valve can be an all-in-one product, factory assembled and factory pressure tested which can be easily connected to the hydronic systems 30 without a need to do many on-site installation works. Also, the multi-functional flow control valve has to be designed, optimized and tested to operate efficiently consuming minimal space, with less weight, easy to handle, maintain and installed in multiple hydronic systems and other applications.

### SUMMARY

An optimized multi-functional flow control device for maintaining a substantially specific flow rate of fluid in hydronic systems is disclosed.

In one aspect, a multi-functional flow control device optimized for maintaining a substantially specific flow rate of fluid with the requirements to properly connect, commission, set-to-work, maintain, repair, and/or replace hydronic system. The device includes two valve housings hydraulically communicating with each other, one is fixed to the supply line and the other is connected to the return line connection point of the hydronic system. The supply line is configured to a first valve housing having a primary inlet port for inflow of fluid and primary outlet port for outflow of fluid fixedly connected to an opening end of a hydronic system, and the return line is configured to a second valve housing having a primary inlet port for inflow of fluid and primary outlet port for outflow of fluid fixedly connected to a closing end of a hydronic system. The two valve housings are configured with one or more cylinders having openings in the form of perforations strategically located when aligned along the length of each of the housing by providing pre-determined angles of rotation to perform multiple fluid flow function operations.

In another aspect, each of the two valve housings have a primary inlet port and a primary outlet port, secondary inlet ports and secondary outlet ports, multiple cylinders with strategically positioned peripheral openings. A first valve housing includes a first hollow cylinder, a mesh strainer, a drain valve, a cover plate, a handle and stem mechanism with a stem dial. A second valve housing includes a second hollow cylinder, a nested cylinder, a venturi tube, a cover plate, a motor, a handle and stem mechanism. Also, any other internal component can be added inside the first hollow cylinder to provide certain functions e.g., non-return valve.

Additional features and advantages of the invention will be made apparent from the following detailed description of illustrative embodiments that proceed with reference to the accompanying drawings.

### BRIEF DESCRIPTION OF THE DRAWINGS

The summary above, as well as the following detailed description of preferred embodiments, is better understood when read in conjunction with the appended drawings. For the purpose of illustrating the invention, exemplary constructions of the invention are shown in the drawings. The invention is not limited to the specific methods and instrumentalities disclosed however. Moreover, those in the art will understand that the drawings are not to scale. Where possible, like elements are indicated by identical numbers. The following configuration is one example of how this invention can be applied, however it is not limited to this configuration and any other configuration can be used.

FIG. 1 illustrates profile of a first valve housing having a primary inlet port and a primary outlet port with a first hollow cylinder for the fluid flow provided therein.

FIG. 2(a) depicts tabulation of multiple modes of operation with predetermined angles of rotation of the first hollow cylinder having the primary inlet port and the primary outlet port in the first valve housing.

FIG. 2(b) depicts table showing the opening and closing of the perforations with predetermined angles of rotation in the upper portion and the lower portion of the first hollow cylinder along with the drain valve.

FIG. 2(c) illustrates perspective views of the first hollow cylinder having multiple peripheral openings in the form of perforations in the first valve housing.

FIG. 2(d) FIG. 2(e), FIG. 2(f), FIG. 2(g) and FIG. 2(h) illustrates top view of the predetermined angles of rotation of the first hollow cylinder in the first valve housing to perform multiple fluid flow function operations indicated by the stem dial.

FIG. 3(a) and FIG. 3(b) illustrate the normal mode of operation of the first valve housing.

FIG. 3(c) illustrates the schematic view of the first valve housing and the direction of fluid flow configured in the hydronic system.

FIG. 4(a), FIG. 4(b), FIG. 4(c) and FIG. 4(d) illustrates the cleaning with two spray nozzles and strainer back flow flushing mode of operation of the first valve housing.

FIG. 4(e) illustrates the schematic view of the first valve housing and the direction of fluid flow configured in the hydronic system.

FIG. 5(a) and FIG. 5(b) illustrate the closing mode of operation with the removal of the drain cap.

FIG. 5(c) illustrates the exploded view of the first valve housing.

FIG. 5(d) illustrates the schematic view of the first valve housing with the absence of fluid flow in the hydronic system for maintenance and cleaning

FIG. 6(a) and FIG. 6(b) illustrate the coil cleaning mode of operation of the first valve housing.

FIG. 6(c) illustrates the schematic view of the first valve housing and the direction of fluid flow configured in the hydronic system.

FIG. 7(a) and FIG. 7(b) illustrate the by-pass flushing mode of operation of the first valve housing.

FIG. 7(c) illustrates the schematic view of the first valve housing and the direction of fluid flow configured with the second valve housing in the hydronic system.

FIG. 8 shows the fundamental components of an example closed hydronic system.

FIG. 9 illustrates profile of a second valve housing having a primary inlet port and a primary outlet port with a nested hollow cylinder for the multiple fluid flow flushing provided therein.

FIG. 10 illustrates a conventional hydronic system.

### DETAILED DESCRIPTION OF ILLUSTRATIVE EMBODIMENTS

The description below illustrates embodiments of the claimed invention to those of skill in the art. This description illustrates aspects of the invention but does not define or limit the invention, such definition and limitation being contained solely in the claims appended hereto. Those of skill in the art will understand that the invention can be implemented in a number of ways different from those set out here, in conjunction with other present or future technologies.

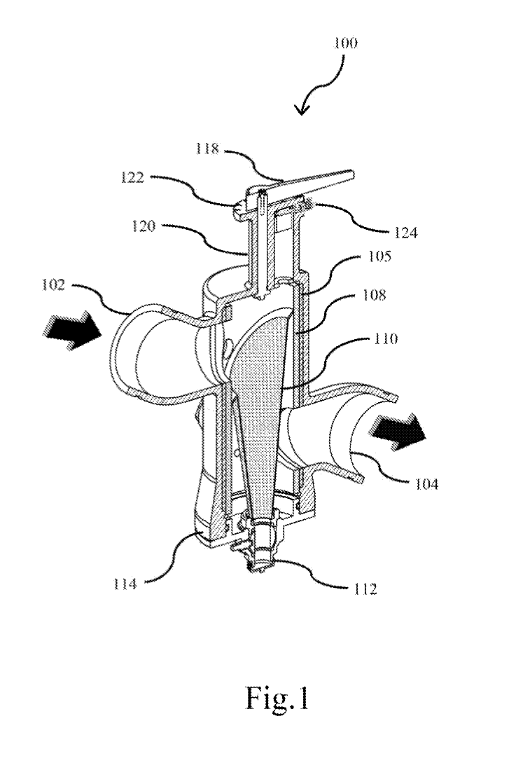

FIG. 1 illustrates profile of a first valve housing having a primary inlet port and a primary outlet port with a first hollow cylinder for the fluid flow provided therein. As shown, FIG. 1 includes a first valve housing 100, a primary inlet port 102, a primary outlet port 104, a diaphragm seal 105, a first hollow cylinder 108, a mesh strainer 110, a drain valve 112, a cover plate 114, a handle 118 and stem 120 mechanisms, a stem dial 122 and an automatic air vent 124.

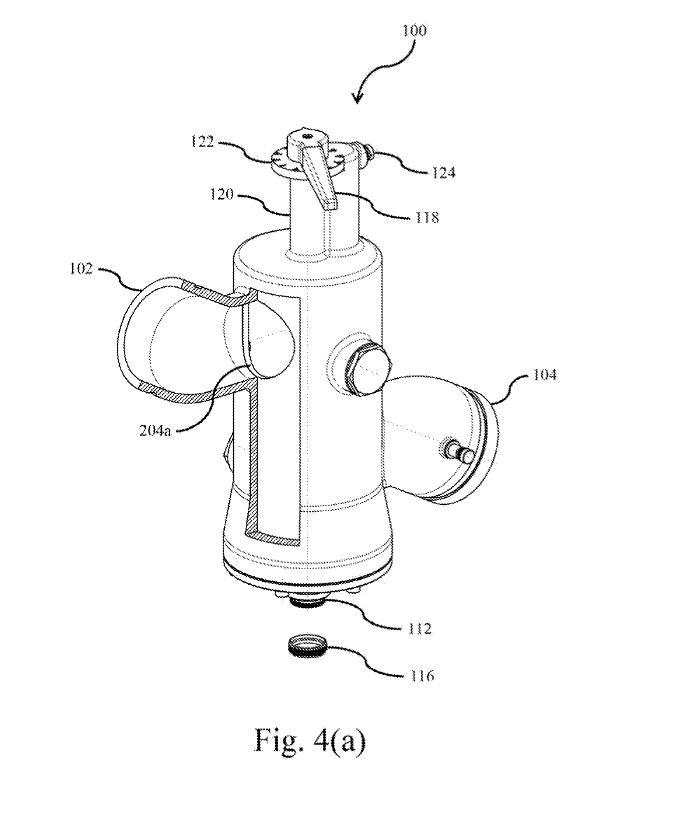

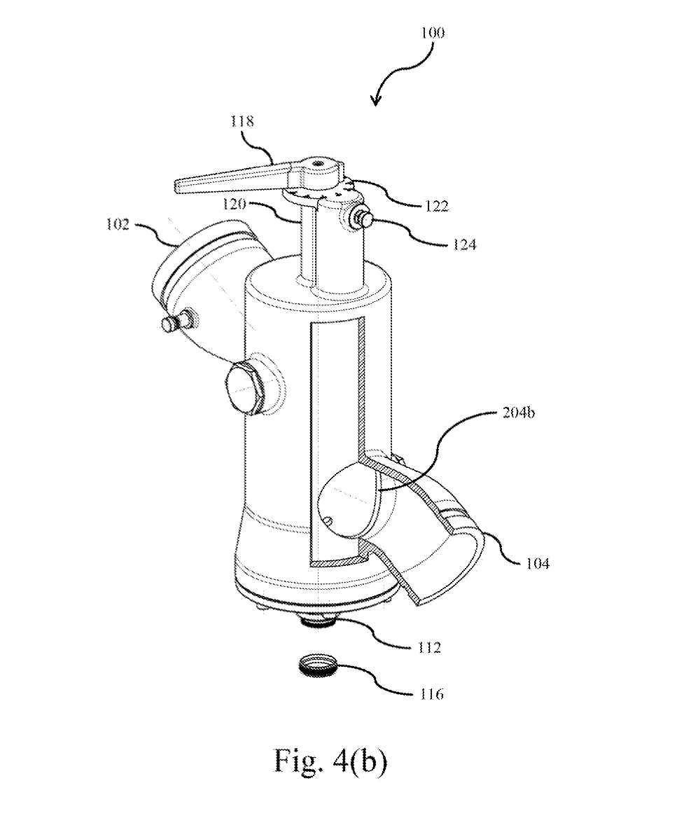

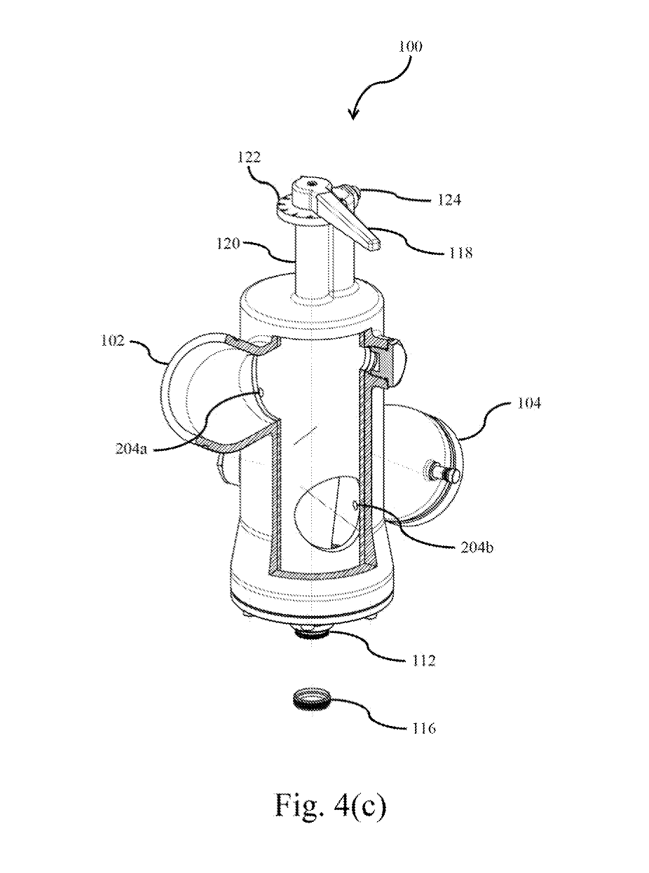

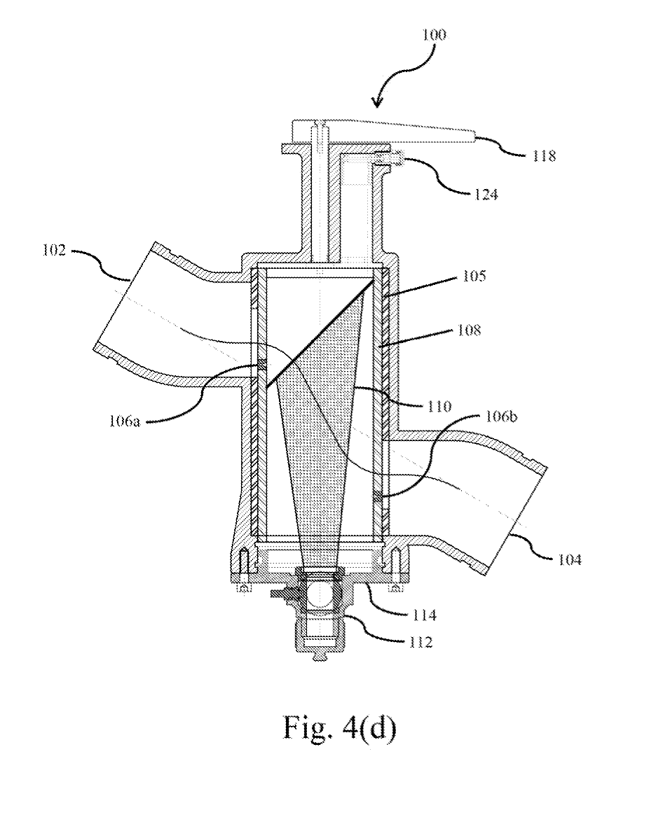

The first hollow cylinder 108 provides isolation between the primary inlet port 102 and the primary outlet port 104 by the pre-determined angles of rotation The different pre-determined angles of rotation includes 0°, 120°, 150°, 210° and 270° rotation angles indicated by the stem dial 122. The handle 118 and stem 120 mechanisms are connected to first hollow cylinder 108 configured for the required operation mode. The first hollow cylinder 108 has two spray nozzles 106a and 106b as shown in FIG. 4 (d) for the fluid to flow into the primary inlet port 102 and the fluid to flow out of the primary outlet port 104 of the first valve housing 100. The isolation of the first valve housing 100 by the pre-determined angles of rotation of the first hollow cylinder 108 allows cleaning of the particulate material inside the mesh strainer 110 having a drain valve 112 provided with a cover plate 114. The mesh strainer 110 is conically shaped for configuration with the drain valve 112.

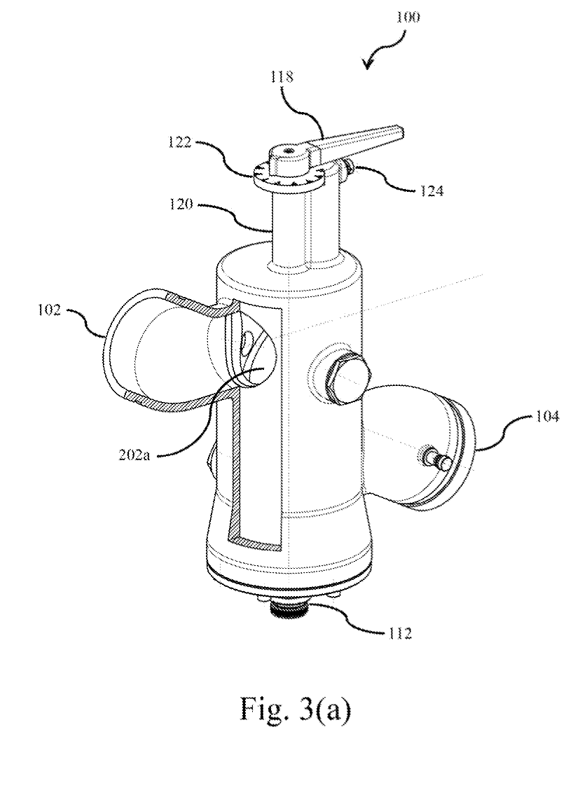

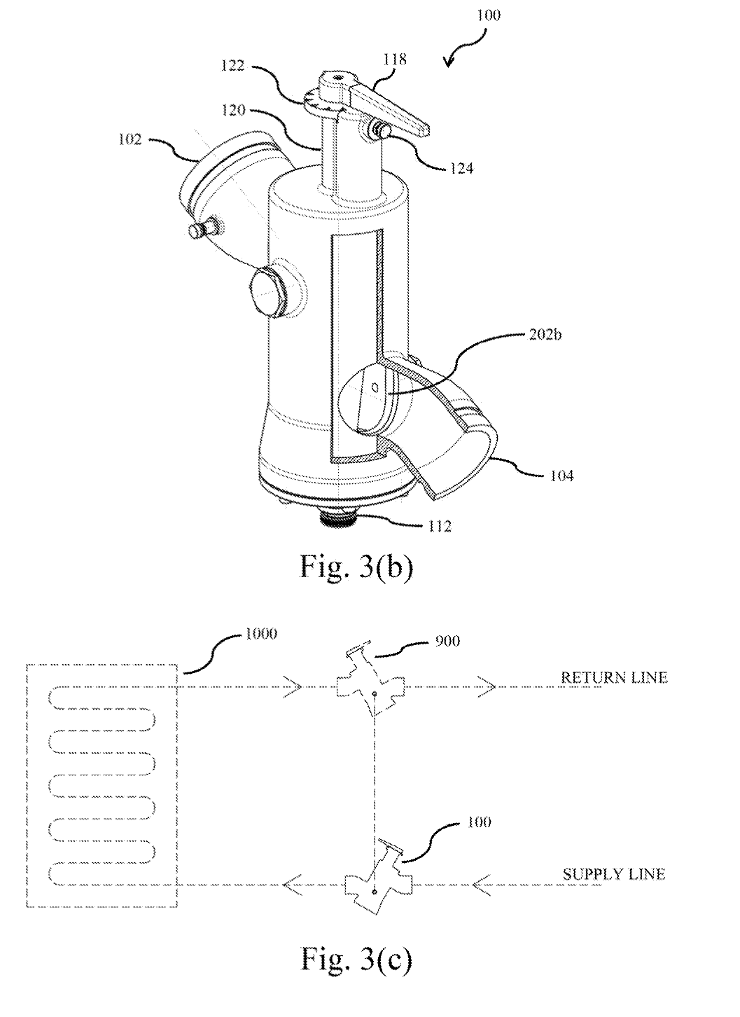

Further, as shown in FIG. 1, the stem dial 122 is provided to indicate the relative amount of first valve housing 100 opening of the first hollow cylinder 108 during the predetermined angles of rotation as described below with reference from FIG. 3(a) to FIG. 7(c) in considerable details. An automatic air vent 124 as shown in all the figures from FIG. 1 to FIG. 7(c) is effectively integrated within the first valve housing 100 for the removal of air and other gases during servicing of the first valve housing 100. The automatic air vent 124 is provided to prevent the excess air being trapped in the first valve housing 100 which may cause excessive noise and increase maintenance costs.

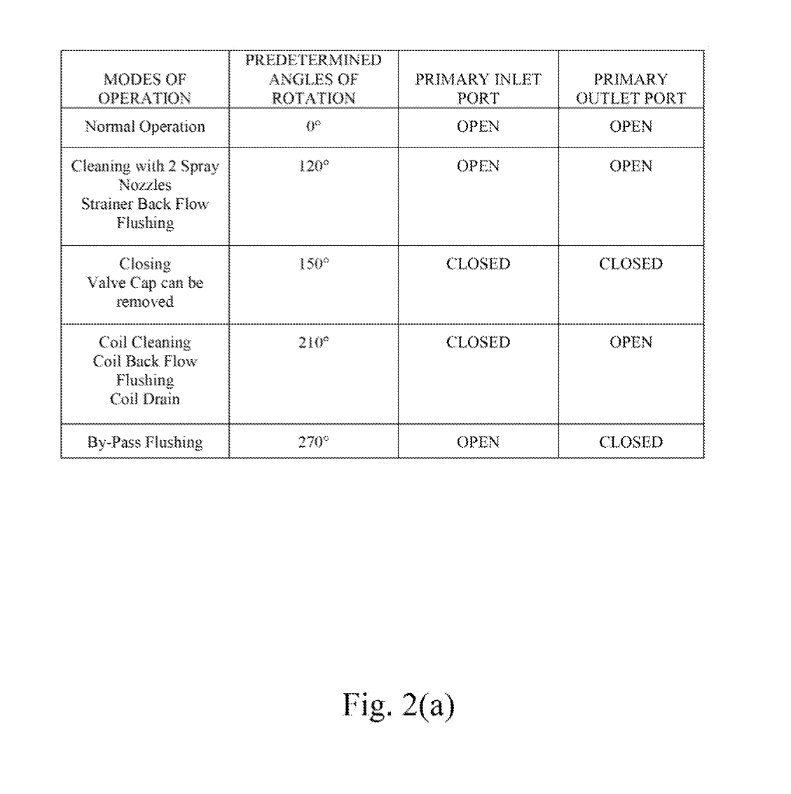

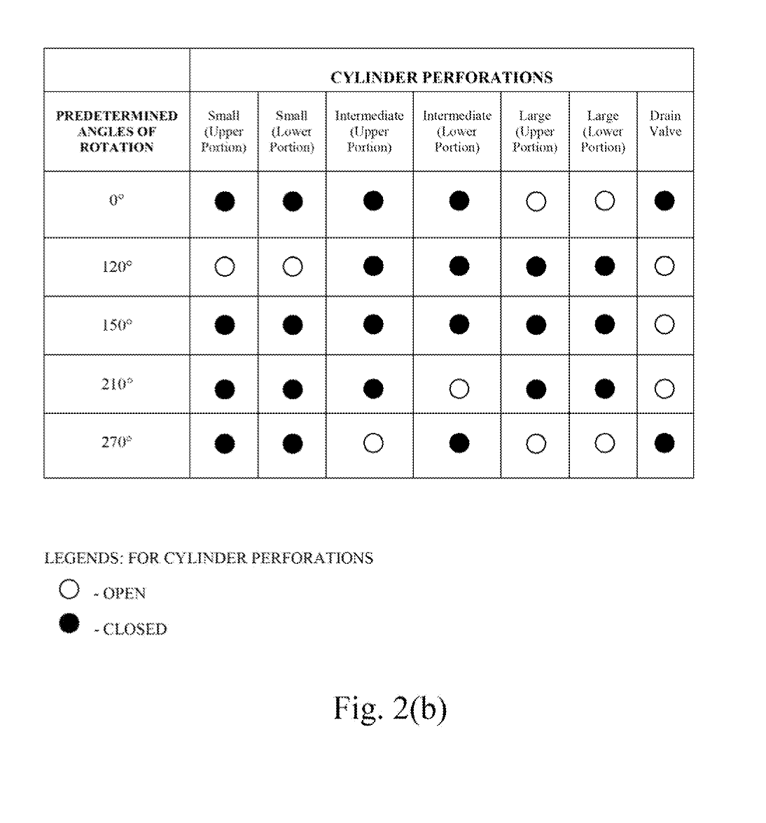

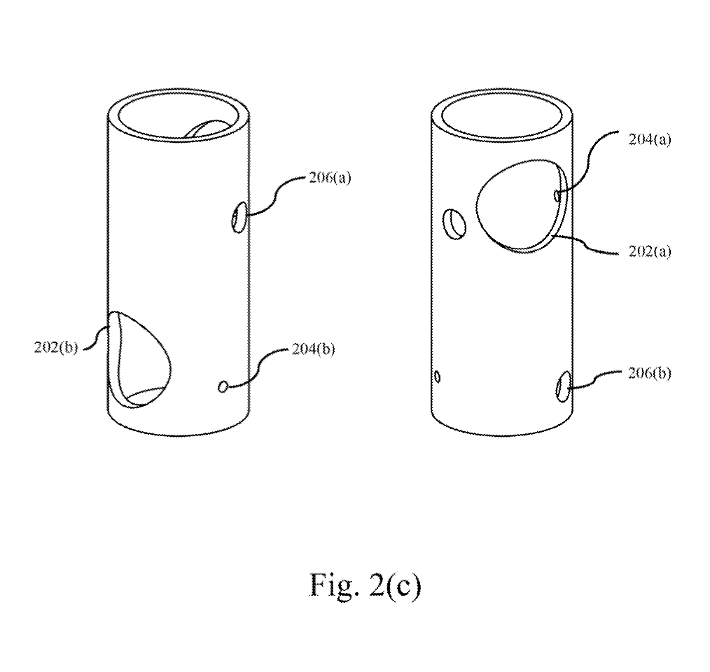

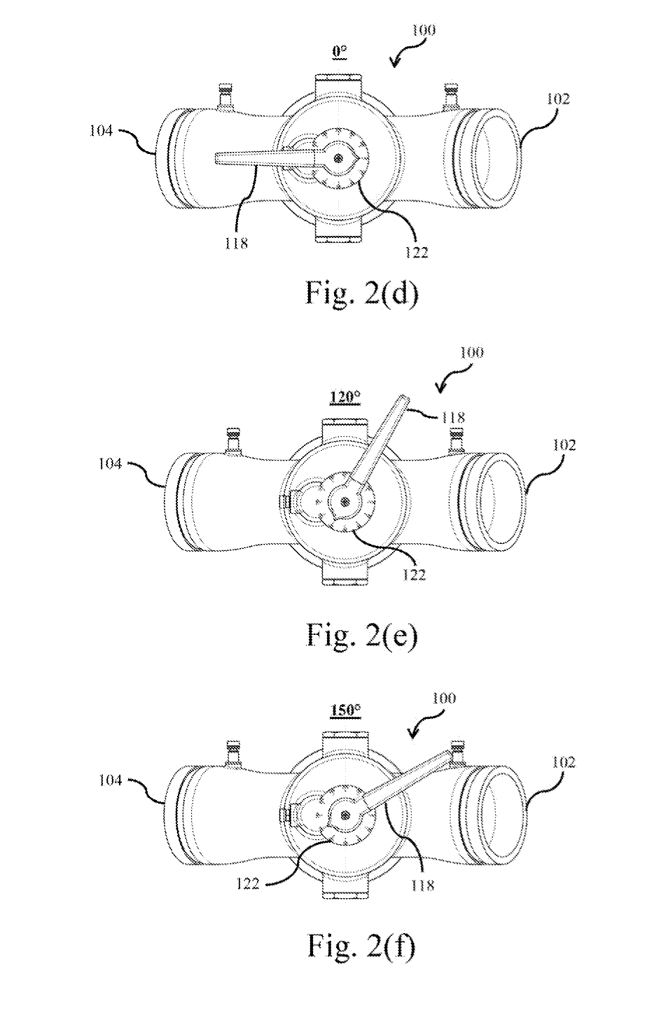

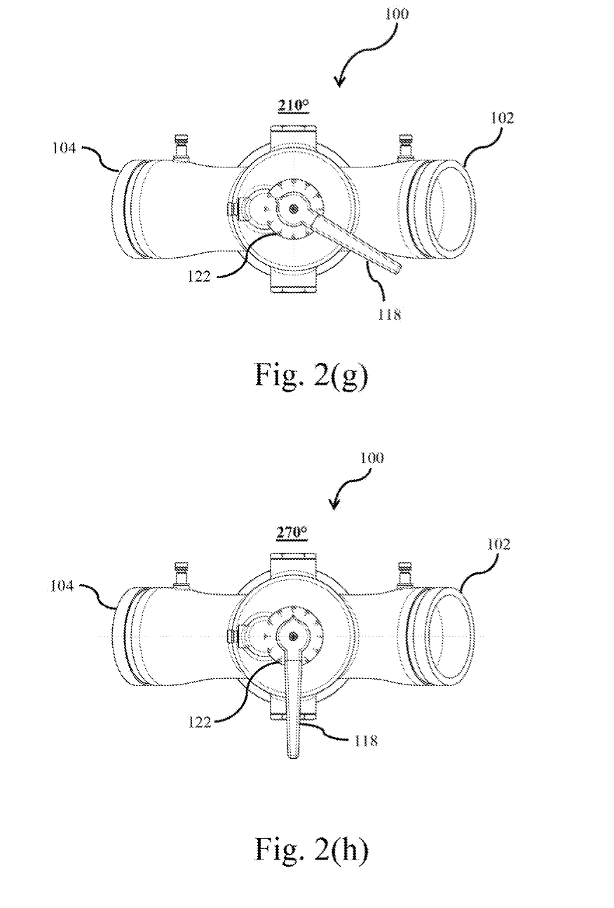

FIG. 2(a) depicts tabulation of multiple modes of operation with predetermined angles of rotation of the first hollow cylinder having the primary inlet port and the primary outlet port in the first valve housing.

As shown in the FIG. 2(a), during the normal operation both the primary inlet port 102 and the primary outlet port 104 are in the open position. During the rotation of the first hollow cylinder 108 at an angle of 120°, both the primary inlet port 102 and the primary outlet port 104 are in the open position. Further, with the rotation of the first hollow cylinder 108 at an angle of 150°, both the primary inlet port 102 and the primary outlet port 104 are in the closed position. Furthermore, with the rotation of the first hollow cylinder 108 at an angle of 210°, the primary inlet port 102 is closed and the primary outlet port 104 is in the open position. In the by-pass flushing mode of operation, the first hollow cylinder 108 is rotated at an angle of 270°, with the primary inlet port 102 in the open position and the primary outlet port 104 in the closed position.

FIG. 2(b) depicts table showing the opening and closing of the perforations with the predetermined angles of rotation in the upper portion and the lower portion of the first hollow cylinder along with the drain valve.

FIG. 2(c) illustrates perspective views of the first hollow cylinder having multiple peripheral openings in the form of perforations in the first valve housing. There are six perforations provided in the first hollow cylinder 108 are shown in the FIG. 2 (c) represented as 202(a) and 202 (b), 204(a) and 204 (b), and 206(a) and 206 (b) located respectively in the upper portion and the lower portion of the first hollow cylinder 108. As shown in the FIG. 2 (c), the first hollow cylinder 108 shows all the six perforations equidistant from each other with a variable diameter.

FIG. 2(d) FIG. 2(e), FIG. 2(f), FIG. 2(g) and FIG. 2(h) illustrates top view of the predetermined angles of rotation of the first hollow cylinder in the first valve housing to perform multiple fluid flow function operations indicated by the stem dial.

FIG. 3(a) and FIG. 3(b) illustrate the normal mode of operation of the first valve housing 100. In this operation, both the primary inlet port 102 and the primary outlet port 104 are open. Fluid flows into the primary inlet port 102 and flows out of the primary outlet port 104. During normal operation, the first hollow cylinder 108 shows perforations 202(a) and 202 (b) in the upper portion and the lower portion of the first hollow cylinder 108 in an open position with both the primary inlet port 102 and the primary outlet port 104 open for the fluid to flow in the first valve housing 100 as shown in the FIG. 3(a) and FIG. 3(b).

The perforations 204(a) and 204 (b), and 206(a) and 206 (b) are closed in the first hollow cylinder 108. The perforations 202(a) and 202 (b) in the first hollow cylinder 108 coincide with the openings of the primary inlet port 102 and the primary outlet port 104. Also, the drain valve 112 remains closed in the normal operation.

FIG. 3(c) illustrates the schematic view of the first valve housing and direction of fluid flow configured in the hydronic system. As shown in FIG. 3(c), fluid enters in the first valve housing 100 through the primary inlet port 102. And, the fluid flows out of the first valve housing 100 through the primary outlet port 104 connected to the opening end of the hydronic system 1000.

FIG. 4(a), FIG. 4(b), FIG. 4(c) and FIG. 4(d) illustrates the cleaning with two spray nozzles and strainer back flow flushing mode of operation of the first valve housing. The cleaning of the mesh strainer 110 occurs with the two spray nozzles 106a and 106b located in the first hollow cylinder 108 with perforations 204(a) and 204 (b), when viewed with both primary inlet port 102 and the primary outlet port 104 in an open position as shown in the FIG. 4(d). The predetermined angle of rotation during this operation is 120°. The fluid enters the first valve housing 100 through the primary inlet port 102 and the primary outlet port 104 having the spray nozzles 106a and 106b respectively located in the first hollow cylinder 108. The spray nozzles 106a and 106b are precision devices that facilitate distribution of liquid in the first hollow cylinder 108. Fluid comes out from the two spray nozzles 106a and 106b at high speed. Thereby, facilitates cleaning of the mesh strainer 110.

As shown in the FIG. 4(a), FIG. 4(b) and FIG. 4(c) the first hollow cylinder 108 shows perforations 204(a) and 204 (b) in the upper portion and the lower portion in an open position. And, perforations 202(a), 202 (b), 206(a) and 206 (b) in the upper portion and the lower portion of the first hollow cylinder 108 are in the closed position with respect to the first valve housing 100. The drain valve 112 is opened to remove the mesh strainer 110 during cleaning as shown in the FIG. 4(d).

FIG. 4(e) illustrates the schematic view of the first valve housing and the direction of fluid flow configured in the hydronic system 1000.

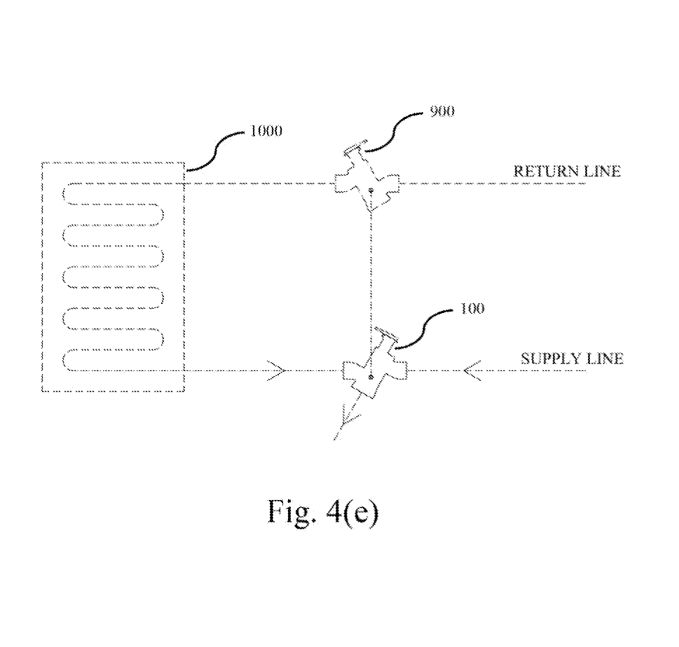

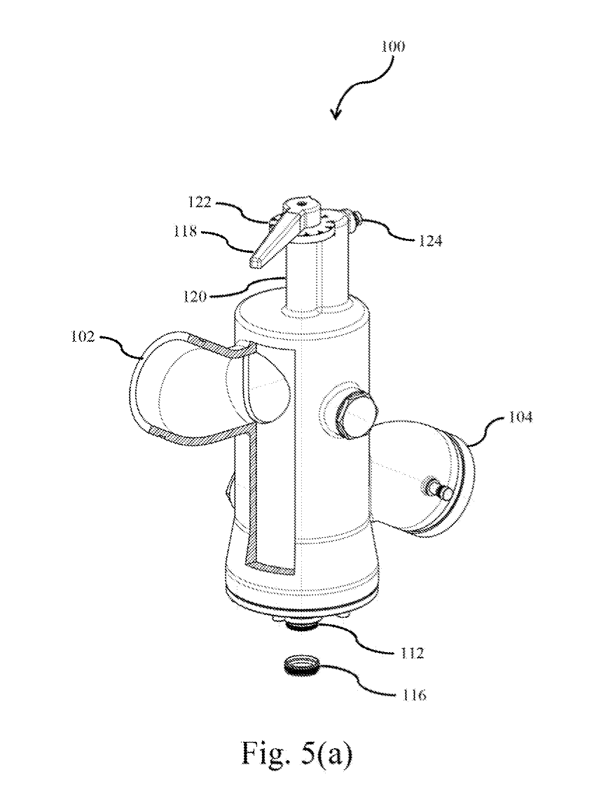

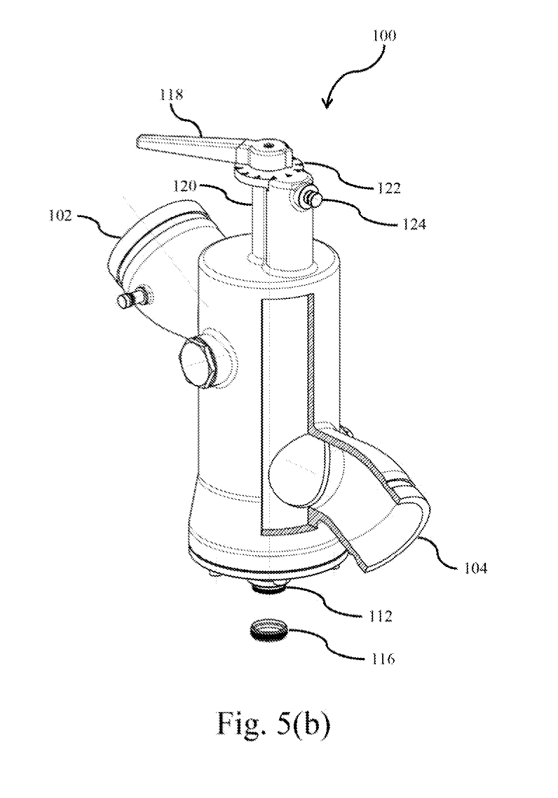

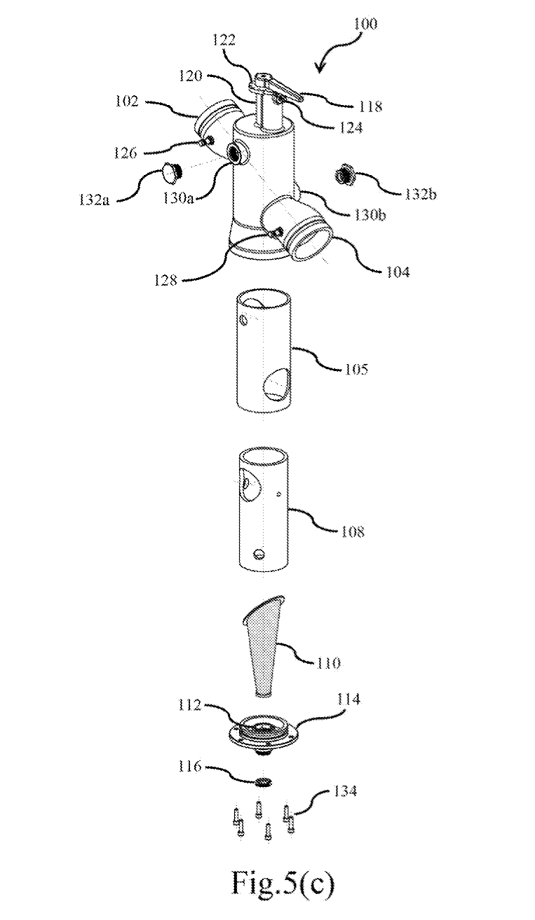

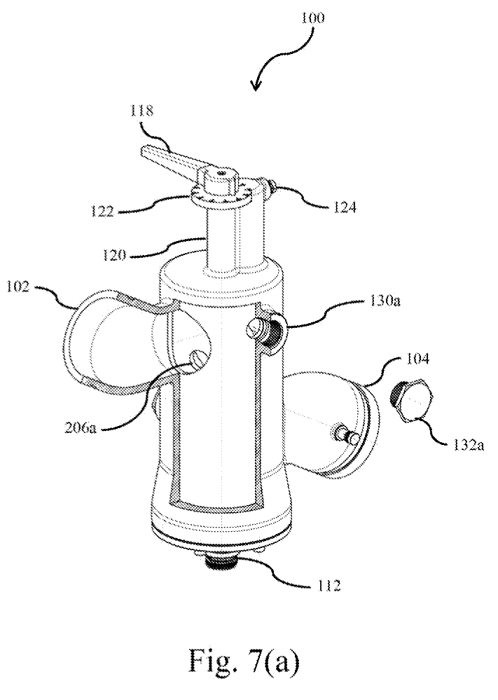

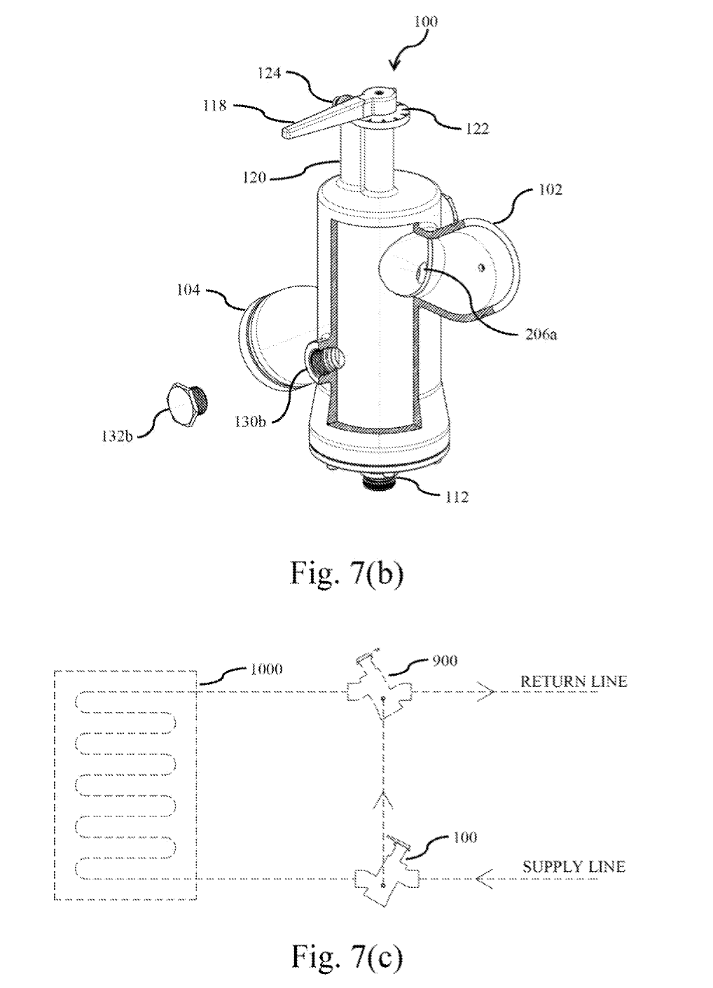

Further, FIG. 5(a) and FIG. 5(b) illustrate the closing mode of operation with the removal of the drain cap. As shown in the FIG. 5(a) and FIG. 5(b) the first hollow cylinder 108 is rotated at an angle of 150°, both the primary inlet port 102 and the primary outlet port 104 are isolated by having them in the closed position. Also, the entire first hollow cylinder 108 having all the six perforations is in the closed position. It is ideal for the removal of the drain cap 116 with the fasteners 134 having the drain valve 112 provided with the cover plate 114 as shown in the FIG. 5(c). A diaphragm seal 105 such as the Ethylene propylene diene monomer (M-class) rubber (EPDM) membrane seals the first hollow cylinder 108 to prevent leakage of fluid in the first valve housing 100. Pressure port 126 is provided for readout of the pressure difference across the first valve housing 100 between the primary inlet port 102 and the primary outlet port 104. Temperature port 128 is provided for readout of the temperature difference across the first valve housing 100 between the primary inlet port 102 and the primary outlet port 104. The bypass ports 130(a) and 130(b) are provided by having bypass plugs 132(a) and 132(b) to perform by-pass flushing operation as shown in the FIG. 7(a) and FIG. 7(b).

FIG. 5(d) illustrates the schematic view of the first valve housing 100 with the absence of fluid flow in the hydronic system 1000 for maintenance and cleaning of one or more internal components such as the mesh strainer 110.

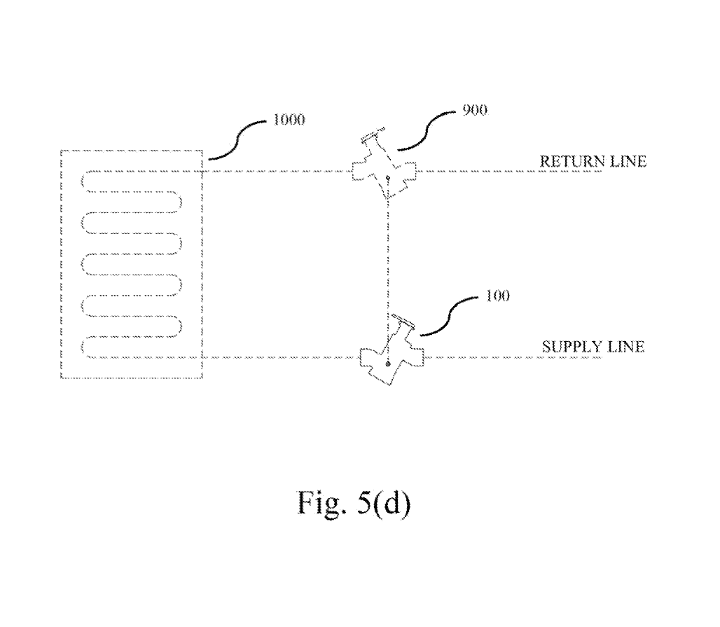

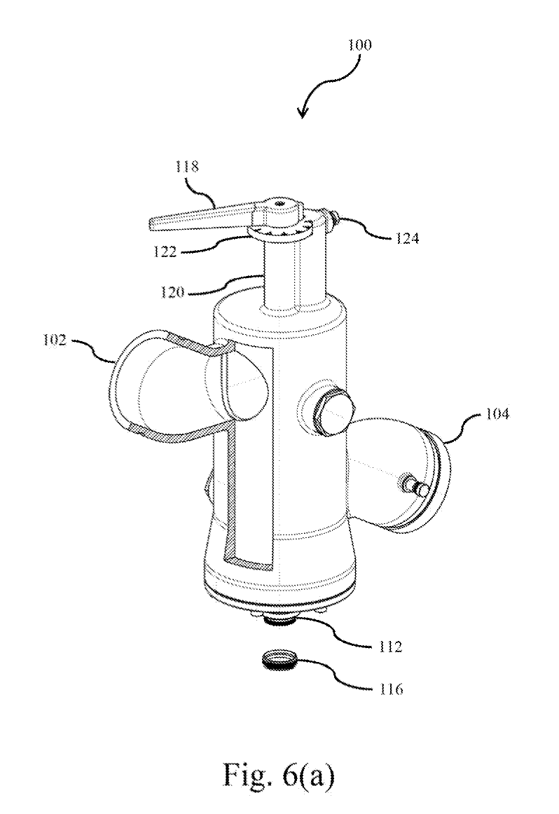

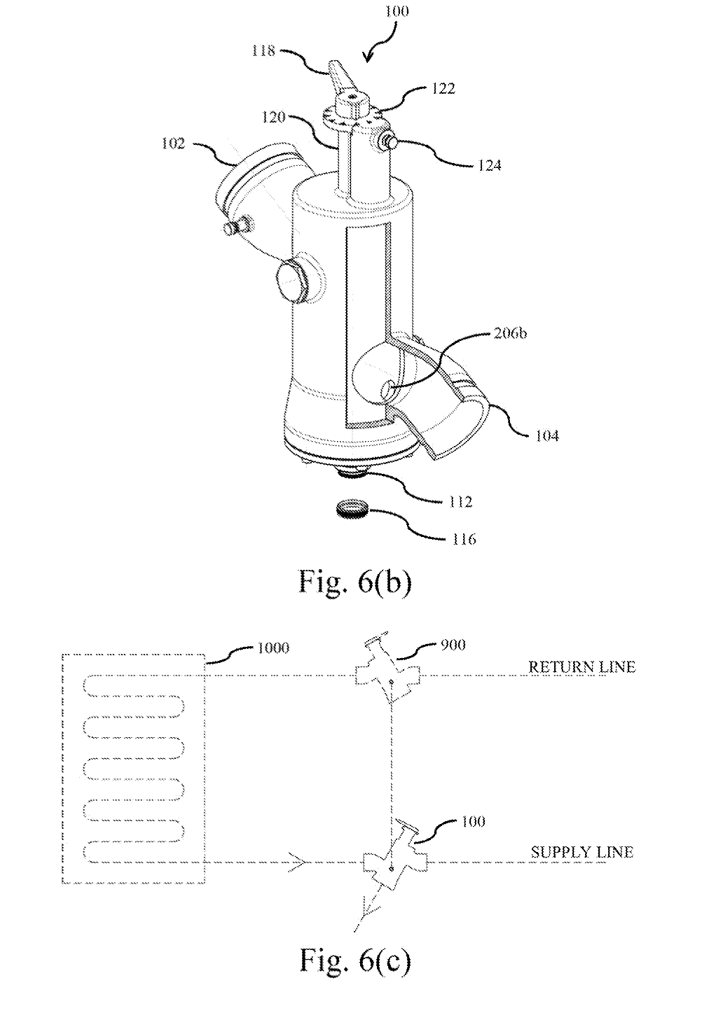

As shown in the FIG. 6(a) and FIG. 6(b) the first hollow cylinder 108 is rotated at an angle of 210°, the primary inlet port 102 is closed and the primary outlet port 104 is in an open position. The mode of operation includes coil cleaning with coil back flow flushing and coil drain. During the coil back flow flushing, the opening of the primary outlet port 104 allows for cleaning of the hydronic system 1000 connected to the opening end with the supply line configured to the first valve housing 100. The coil drain valve 112 is opened to allow the fluid to be drained out completely from the hydronic system 1000 as shown in FIG. 6(c).

As shown in the FIG. 6(a) and FIG. 6(b), only the lower portion of the first hollow cylinder 108 having the perforation 206 (b) is in the open position, while the rest of the perforations in the first hollow cylinder 108 are closed. FIG. 6(c) illustrates the schematic view of the first valve housing and the direction of fluid flow configured in the hydronic system 1000.

As shown in the FIG. 7(a) and FIG. 7(b) the first hollow cylinder 108 is rotated at an angle of 270°, the primary inlet port 102 is open and the primary outlet port 104 is in the closed position. The by-pass flushing operation is performed during this stage. The first valve housing 100 shows perforation 206(a) in the upper portion of the first hollow cylinder 108 in an open position. Also, the drain valve 112 remains closed in the by-pass flushing operation. The fluid flows into the primary inlet port 102 by coinciding through the perforation 206(a) in the upper portion of the first hollow cylinder 108 and flows out of the first valve housing 100 into the second valve housing 800 either from the bypass ports 130(a) and 130(b) by the removal of the bypass plugs 132(a) and 132(b) as shown in the FIG. 7(a) and FIG. 7(b). The by-pass between the supply line and the return line is completed with the configuration of the first valve housing 100 to the second valve housing 900.

FIG. 7(c) illustrates the schematic view of the first valve housing and the direction of fluid flow configured with the second valve housing in the hydronic system 1000.

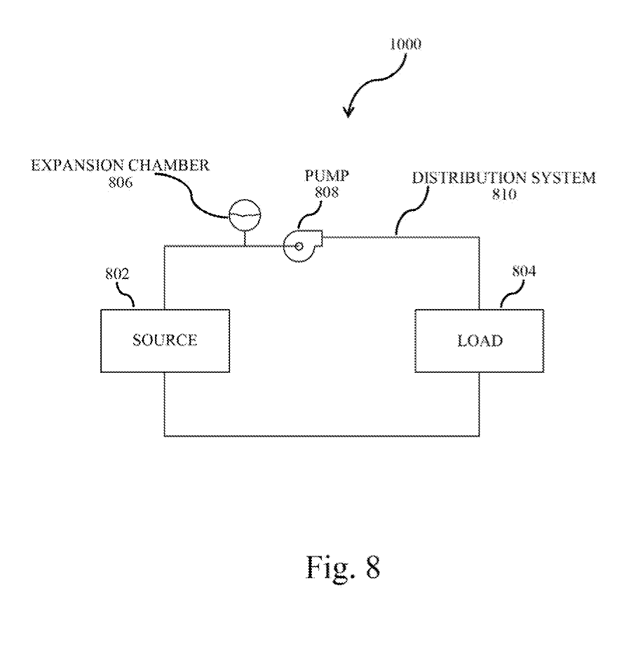

FIG. 8 shows the fundamental components of an example closed hydronic system. The fundamental components include Source, Loads, Expansion chamber, Pump and the distribution system.

Source 802 is the point where heat is added to (heating) or removed from (cooling) the system. Ideally, the amount of energy entering or leaving the source equals the amount entering or leaving through the load. Any device that can be used to heat or cool water under controlled conditions can be used as a source device. The most common source devices for heating include hot water generator or boiler, steam-to-water heat exchanger, solar heating panels, exhaust gas heat exchanger, incinerator heat exchanger, heat pump condenser, air-to-water heat exchanger. And, cooling source devices include electric compression chiller, thermal absorption chiller, heat pump evaporator, air-to-water heat exchanger, water-to-water heat exchanger and others.

The load 804 is the device that causes heat to flow out of or into the hydronic system 1000. Outward heat flow characterizes a heating system, and inward heat flow characterizes a cooling system. For example, heating load devices include preheat coils in central units, heating coils in central units, zone or central reheat coils, finned-tube radiators, fan-coil units and others. While, the cooling load devices, for example, include coils in central units, fan-coil units, induction unit coils, radiant cooling panels, water-to-water heat exchangers and others.

The expansion chamber 806 serves both a thermal function and hydraulic function. In its thermal function the tank provides a space into which the non compressible liquid can expand or from which it can contract as the liquid undergoes volumetric changes with changes in temperature. To allow for this expansion or contraction, the expansion tank provides an interface point between the system fluid and a compressible gas.

The centrifugal pumps are the most commonly type of pumps 808 used in hydronic systems. Circulating pumps used in water systems can vary in size from small in-line circulators delivering 5 gpm at 6 or 7 ft head to base-mounted or vertical pumps handling hundreds or thousands of gallons per minute, with pressures limited only by the characteristics of the system. The distribution system 810 is the piping connecting the various other components of the system. The primary considerations in designing this system are (1) sizing the piping to handle the heating or cooling capacity required and (2) arranging the piping to ensure flow in the quantities required at design conditions and at all other loads.

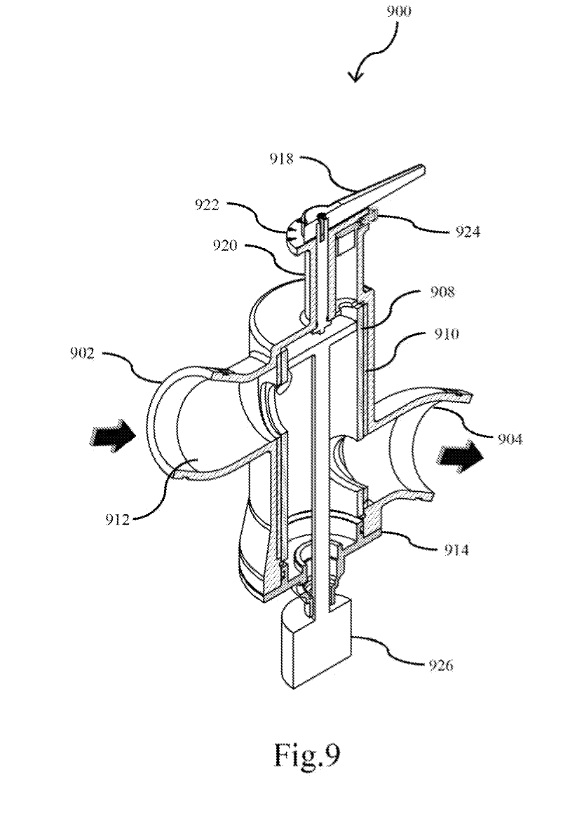

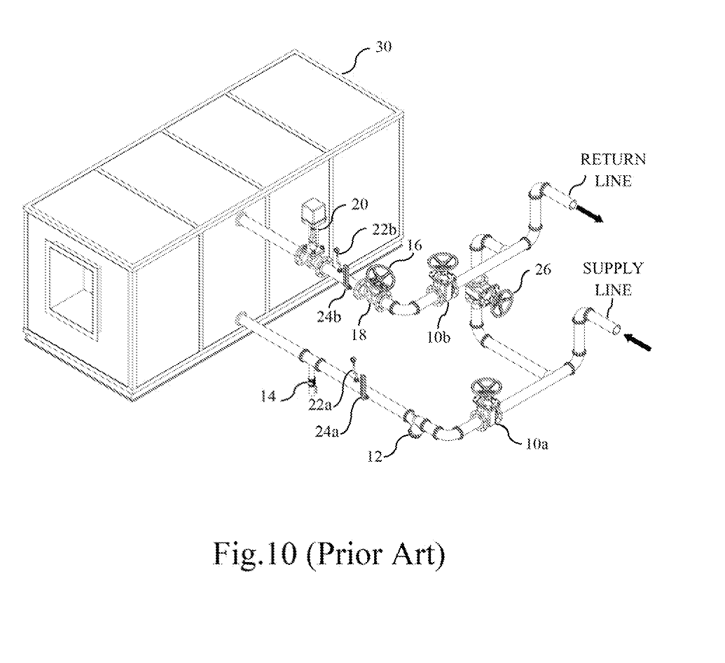

FIG. 9 illustrates profile of a second valve housing having a primary inlet port and a primary outlet port with a nested cylinder for the fluid flow flushing provided therein. As shown, FIG. 9 includes a second valve housing 900, a primary inlet port 902, a primary outlet port 904, a second hollow cylinder 908, a nested cylinder 910, a venturi tube 912, a cover plate 914, a handle 918 and stem 920 mechanisms, a stem dial 922, an automatic air vent 924 and a motor 926.

The second hollow cylinder 908 is configured within the second valve housing 900 to isolate the primary inlet port 902 and the primary outlet port 904. The isolation provides the operation for multiple internal fluid flow flushing. The nested cylinder 910 is configured for fluid flow control and self balancing. Further, the venturi tube 912 is characterized by a constricted flow passage for measuring the fluid flow. The venturi tube 912 is at least proximally located at the primary inlet port 902 of the second valve housing 900.

The cover plate 914 seals the base of the second valve housing 900. The motor 926 is a hydraulic control actuator provided in the second valve housing 900. The motor 926 can be controlled either electrically or pneumatically. The handle 918 and stem 920 mechanisms are provided for the rotation of the second hollow cylinder 908 to provide fluid flow in the second valve housing 900. The handle 918 and stem 920 mechanisms can be any suitable shape and be used as a substitute for the cylindrical rod which is used in the flow control device, for achieving the purpose of the invention. Further, the cylindrical rod has a sufficient strength to bear the load of the other devices mounted over it, without undergoing any deflections or getting deformed. The handle 918 and stem 920 mechanisms is positioned adjacently along the length of the second valve housing 900. The second valve housing 900 also includes at least one of predetermined pressure port and predetermined temperature port (not shown in the figure).

The optimized flow control device of the claimed invention can be used in many applications where a demand for a specific flow rate of a fluid exists. For example, many hydronic systems including water-cooled chillers and other cooling units use water as an active heat transfer medium and the device would find its application in controlling flow through the water piping networks through such systems, wherever required. Also, the configuration of both the first valve housing 100 and the second valve housing 900 may be used in multiple positions of an example closed hydronic system 1000 in FIG. 8. For example, either of the first valve housing 100 and the second valve housing 900 may be interchangeably configured either between the Source 802, the load 804, the expansion chamber 806, the pump 808 and/or the distribution system 810.

Further, in the example configuration can be used to connect Air handling units, chillers, boilers, cooling towers of heat exchangers to the hydronic circuits.

Although the present invention has been described in considerable details with reference to certain preferred versions thereof, other versions are also possible.

I claim:

1. A multi-functional flow control device optimized for maintaining a substantially specific flow rate of fluid therethrough, the device comprising:
two valve housings hydraulically communicating with each other having a supply line and a return line, the supply line is configured to a first valve housing having a primary inlet port for inflow of fluid and primary outlet port for outflow of fluid fixedly connected to an opening end of a hydronic system, and the return line is configured to a second valve housing having a primary inlet port for inflow of fluid and primary outlet port for outflow of fluid fixedly connected to a closing end of a hydronic system, wherein the two valve housings are configured with one or more cylinders having uniform peripheral openings in the form of perforations strategically located when aligned along the length of each of the housing by providing a plurality of different pre-determined angles of rotation to perform multiple fluid flow operations.

2. The device of claim 1, wherein at least one of the pre-determined angles of rotation is performed for specific fluid flow operation in both clockwise direction and counter-clockwise direction.

3. The device of claim 1, wherein at least one of the cylinder is located inside the valve housing to acquire specific function for one of the pre-determined angles of rotation.

4. The device of claim 1, wherein each of a plurality of different pre-determined angles of rotation comprises of 0°, 120°, 150°, 210° and 270° rotation angles.

5. The device of claim 1, wherein the pre-determined angles of rotation is indicated by a stem dial.

6. The device of claim 1, wherein the first valve housing further comprises a first hollow cylinder, a diaphragm seal, a mesh strainer, a drain valve, a cover plate, a handle and a stem mechanism, and an automatic air vent.

7. The device of claim 1, wherein the first valve housing comprising the mesh strainer is conically shaped for configuration with the drain valve.

8. The device of claim 1, wherein the first hollow cylinder is provided within the first valve housing to isolate the primary inlet port and the primary outlet port by the pre-determined angles of rotation of the first hollow cylinder connected with a handle and a stem mechanism indicated by the stem dial for fluid flow therethrough.

9. The device of claim 1, wherein the first hollow cylinder has at least one or more of peripheral openings in the form of perforations located in the upper portion and the lower portion of the first hollow cylinder at the primary inlet port and the primary outlet port.

10. The device of claim 1, wherein the isolation of the first valve housing by the pre-determined angles of rotation of the first hollow cylinder allows cleaning of the particulate material inside the mesh strainer having the drain valve provided with a cover plate.

11. The device of claim 1, wherein an automatic air vent integrated within the first valve housing is provided to expel excess air during one of multiple fluid flow operations.

12. The device of claim 1, wherein the second valve housing further comprises a second hollow cylinder, a nested cylinder, a venturi tube, a cover plate, a motor, a handle and a stem mechanism.

13. The device of claim 8, wherein the second hollow cylinder is configured within the second valve housing to isolate the primary inlet port and the primary outlet port.

14. The device of claim 1, wherein the nested cylinder is configured for fluid flow control and self balancing.

15. The device of claim 1, wherein the venturi tube is characterized by a constricted flow passage for measuring the fluid flow.

16. The device of claim 11, wherein the venturi tube is at least proximally located at the primary inlet port of the second valve housing.

17. The device of claim 1, wherein the cover plate seals the base of the second valve housing.

18. The device of claim 1, wherein the motor is a hydraulic control actuator provided in the second valve housing.

19. The device of claim 1, wherein the handle and stem mechanism is provided for the motion of the fluid flow in the second valve housing.

20. The device of claim 1, wherein the first valve housing and the second valve housing comprises at least one of predetermined pressure port provided for readout of the pressure difference and predetermined temperature port provided for readout of the temperature difference across the first valve housing

21. The device of claim 1, wherein the first valve housing has a first dimension data and the second valve housing has a second dimension data wherein at least one of the dimension data comprises at least one of a width, a depth, a length, a distance, a surface area, a volume, center and an angle.
